(19) United States
(12) Patent Application Publication
(10) Pub. No.: US 2022/0274480 A1
(43) Pub. Date: Sep. 1, 2022

(54) Transmission Arrangement, Hybrid Transmission Arrangement, Hybrid Drive Train and Motor Vehicle

(71) Applicant: ZF Friedrichshafen AG, Friedrichshafen (DE)

(72) Inventors: Stefan Beck, Eriskirch (DE); Martin Brehmer, Tettnang (DE); Peter Ziemer, Tettnang (DE); Thomas Kroh, Lindau (DE); Fabian Kutter, Kressbronn (DE); Oliver Bayer, Hörbranz (AT); Johannes Kaltenbach, Friedrichshafen (DE); Matthias Horn, Tettnang (DE); Michael Wechs, Weißensberg (DE); Thomas Martin, Weissensberg (DE); Juri Pawlakowitsch, Kressbronn (DE); Max Bachmann, Friedrichshafen (DE)

(21) Appl. No.: 17/634,748

(22) PCT Filed: Jul. 29, 2020
(86) PCT No.: PCT/EP2020/071326

§ 371 Date: Feb. 11, 2022

(30) Foreign Application Priority Data
Aug. 13, 2019 (DE) 10 2019 212 145.4

(51) Int. Cl. B60K 6/547; B60K 6/48; F16H 3/089

(52) U.S. Cl. CPC B60K 6/547; B60K 6/48; F16H 3/089

(57) ABSTRACT

A transmission arrangement (3, 8, 42, 44, 46, 48) includes at least one transmission input shaft (12, 38) and at least one countershaft (26, 28). A connecting gearwheel (24) is arranged on the countershaft (26) for connecting a differential (34). The connecting gearwheel (24) is connected to a gearwheel (22) for forming a gear step (G4).

### CROSS-REFERENCE TO RELATED APPLICATIONS

The present application is related and has right of priority to German Patent Application No. 102019212145.4 filed in the German Patent Office on Aug. 13, 2019 and is a nationalization of PCT/EP2020/071326 filed in the European Patent Office on Jul. 29, 2020, both of which are incorporated by reference in their entirety for all purposes.

### FIELD OF THE INVENTION

The invention relates generally to a transmission arrangement having at least one transmission input shaft and at least one countershaft, wherein a connecting gearwheel is arranged on the countershaft for connecting a differential.

### BACKGROUND

In known transmissions of a countershaft design, starting from a transmission input shaft, a ratio of the torque and/or of the rotational speed with respect to a countershaft is achieved due to the fact that a spur gear stage is selected, in which an idler gear is rotationally fixed to a shaft and effectuates an appropriate ratio. In addition, it is known that gear steps include, as gear stages, at least one fixed gear and one idler gear. Constant ratios are known as further gear ratios. Constant ratios have two fixed gears and operate in all gears that are formed together with a countershaft.

### SUMMARY OF THE INVENTION

Example aspects of the present invention provide a transmission arrangement that is as compact as possible in the radial direction.

According to example aspects, it is provided, in a transmission arrangement of the type mentioned at the outset, that the connecting gearwheel is connected to a gearwheel in order to form a gear step. Therefore, the connecting gearwheel is simultaneously a gear-step gearwheel. As a result, a gearwheel for forming a gear step can be saved, as the result of which the installation space can be reduced in the axial direction. This saving can be achieved, in principle, in any type of transmission having multiple shafts, in which a gear step is simultaneously established via the connecting gearwheel for connecting the differential. The connection is formed in that the connecting gearwheel and the gearwheel engage into each other.

It is irrelevant, in principle, whether the gearwheel for forming the gear step with the connecting gearwheel is located on the transmission input shaft or on an intermediate shaft. In the present application, the shaft that supports the connecting gearwheel is defined as the countershaft.

Preferably, the connecting gearwheel can be designed as a fixed gear. The gearwheel for forming the gear step that is engaged with the connecting gearwheel can then be designed as an idler gear. When the connecting gearwheel is designed as a fixed gear, a constant step is formed between the countershaft and the differential.

Preferably, the gearwheel for forming the gear step can be arranged on the transmission input shaft. It is pointed out here that the transmission arrangement is preferably designed, of course, as a gear change transmission and has more than one gear step. When mention is made in the following of a gear step, however, unless indicated otherwise, it is assumed this is the gear step that includes the connecting gearwheel.

Advantageously, the connecting gearwheel can be arranged in a middle area of the countershaft. In known gear set arrangements, the connecting gearwheel is often situated at the end of the countershaft in order to achieve a compact arrangement of the gear set planes in such a way that idler gears can be positioned spatially close to one another, and so the gearshift clutches of the idler gears can preferably be designed as two-sided gearshift clutches and, thereby, compact. When the connecting gearwheel itself is part of the gear-step gears, however, such an arrangement is no longer absolutely preferred. Rather, it has been proven that an arrangement of the connecting gearwheel, when utilized as a gear-step gearwheel, is preferably in the middle area.

Advantageously, the transmission arrangement can include a second countershaft, on which a second connecting gearwheel for connecting the differential is arranged. When starting from two countershafts and two connecting gearwheels in the following, the connecting gearwheel that is also a gear-step gearwheel is the first connecting gearwheel.

Preferably, the first connecting gearwheel and the second connecting gearwheel are situated in one gear set plane. The second connecting gearwheel then intermeshes exclusively with one single further gearwheel, namely the gearwheel that connects the differential. It is not possible to provide one further idler gear, in particular, on the transmission input shaft. Nevertheless, as a result, a highly compact axial design of the transmission can be implemented, since the connecting gearwheels and one idler gear are situated in one gear set plane.

Advantageously, the transmission arrangement can include a second transmission input shaft. In a first example alternative, the second transmission input shaft can be arranged on the same axis and axially offset with respect to the first transmission input shaft. As another example alternative, the second transmission input shaft can be mounted on the first transmission input shaft. In this case, the second transmission input shaft is designed as a hollow shaft and surrounds the first transmission input shaft in a predefined area.

Preferably, the first transmission input shaft and the second transmission input shaft are connected by a connecting clutch. Provided the clutch is disengaged, the first transmission input shaft and the second transmission input shaft are rotatable independently of each other. Only after the clutch has been engaged are the first transmission input shaft and the second transmission input shaft connected to each other in a rotationally fixed manner.

Preferably, the connecting clutch for connecting the first transmission input shaft and the second transmission input shaft as well as a gearshift clutch for connecting the gearwheel to a shaft can be arranged in a two-sided engagement device. The gearwheel is the gearwheel for forming a gear step together with the connecting gearwheel.

Preferably, the transmission arrangement can be designed as a gear change transmission. It has at least two discrete gear steps in this case.

Preferably, the gear change transmission can include at least two, in particular precisely two, sub-transmissions. This enables an increased functionality such as, for example, a support of tractive force during a gear ratio change, in particular in the case of an internal combustion engine or an electric gear ratio change.

Preferably, at least one of the sub-transmissions can be designed as a gear change transmission. In particular, all sub-transmissions can be designed as gear change transmissions.

Advantageously, one sub-transmission can have precisely two gear steps. More preferably, the further sub-transmission can have precisely three gear steps. Advantageously, the gear change transmission includes gearwheels and engagement devices. The gearwheels are preferably formed as spur gears.

Preferably, the transmission arrangement is designed as a stationary transmission. In stationary transmissions, the axes of all gearwheels are fixed in relation to the transmission housing during operation.

In addition, the transmission can be designed as a dual clutch transmission. It has two transmission input shafts in this case. Advantageously, the transmission arrangement has precisely two countershafts. As a result, a highly compact arrangement of the gearwheels and engagement devices in the axial direction can be achieved, as the result of which the connection of an electric motor is simplified, as described further below.

In the present invention, a gear step, as described at the outset, is a mechanically implemented ratio between at least two shafts. The overall gear ratio between the internal combustion engine or the drive devices and the wheel has further ratios, wherein the ratios upstream from a gear step, the pre-ratio, can depend on the drive output that is utilized. The post-ratios are usually identical. In an example embodiment shown further below, the rotational speed and the torque of a drive device are transmitted multiple times, namely by at least one gearwheel pair between the output shaft of the drive device and a transmission input shaft. This is a pre-ratio. This is followed by a gearwheel pair—which is also referred to as a gear set—of a gear step with a ratio that is dependent on the gear step. Finally, this is followed by a gearwheel pair between the countershaft and the differential, as a post-ratio. A gear has an overall gear ratio that depends on the input and the gear step. Unless indicated otherwise, a gear relates to the utilized gear step.

Merely for the sake of completeness, it is pointed out that the ascending numbers of the gear steps refer, as usual, to a descending ratio. A first gear step G1 has a higher ratio than a second gear step G2, etc.

If torque is transmitted from the internal combustion engine via a first gear step G1, this is referred to as an internal-combustion-engine gear V1. If the drive device and the internal combustion engine simultaneously transmit torque via the first gear step G1, this is referred to as hybrid gear H11. If only the drive device transmits torque onto the first gear step G1, this is referred to as an electric gear E1. Advantageously, the transmission arrangement has at least four gear steps.

Preferably, the transmission arrangement has two gear set planes fewer than gear steps. In the case of five gear steps, there are three gear set planes. The gear set plane for connecting the differential is included in the count.

In a first example alternative, all gear steps can be utilized in an internal combustion engine-driven and electric manner. As a result, a maximum number of gears can be obtained in combination with a low number of gear steps. In one second example alternative, at least one, in particular precisely one, gear step is associated solely with the internal combustion engine of the drive train. It can be provided, in addition, that one gear step is associated solely with the drive device or one of the drive devices of the transmission device. Preferably, all further gear steps are usable for transmitting torque of the internal combustion engine as well as of one or both drive device(s). The association and usability result from the resultant ratio of a gear step.

Preferably, the transmission device can be designed free of a reversing gearwheel for reversing the direction. In addition, the transmission device can be designed free of a reverse-gear shaft. Therefore, the reverse gear is not produced via the internal combustion engine, but rather by one of the drive devices.

Advantageously, gearwheels of at least one even gear step and one odd gear step can be arranged on the transmission input shaft. In particular, a fixed gear that is engaged with two idler gears can be arranged on the first transmission input shaft. In particular, the third gear step G3 and the fourth gear step G4 can be formed with this fixed gear.

In addition, one idler gear can be arranged on the first transmission input shaft. The idler gear is preferably the gearwheel for forming the gear step with the connecting gearwheel at the countershaft.

Advantageously, a single gearwheel, in particular a gear-step gear, can be arranged on the second transmission input shaft. In particular, a fixed gear can be arranged on the second transmission input shaft. The fixed gear on the second countershaft can also engage with two idler gears to form two gear steps.

In a first example alternative, the first transmission input shaft can be directly connectable or connected to an internal combustion engine. Directly connected refers to a clutch-free connection. In a second example alternative, the output of an internal combustion engine can be connected to the first transmission input shaft via a clutch. In both example alternatives, a damping device can be arranged between a crankshaft, as the output of an internal combustion engine, and the or the first transmission input shaft. The damping device can include a torsion damper and/or a damper and/or a slipping clutch. The torsion damper can be designed as a dual-mass flywheel. The damper can be designed as a rotational speed-adaptive damper.

Preferably, a connecting clutch can be provided for connecting the first transmission input shaft and the second transmission input shaft. This is utilized for coupling the sub-transmissions. However, it is also a clutch for connecting the second transmission input shaft to the internal combustion engine, wherein the connection extends via the first transmission input shaft.

Preferably, the connecting clutch can be arranged at the end of the second transmission input shaft pointing into the transmission. Due to the arrangement of the connecting clutch, for example, in a two-sided engagement device, a compact design of the transmission can be achieved.

In the present invention, an engagement device is understood to be an arrangement having one or two shift element(s). The engagement device is designed to be one-sided or two-sided in this case. A shift element can be a clutch or a gearshift clutch. A clutch is utilized for connecting two shafts in a rotationally fixed manner and a gearshift clutch is utilized for rotationally fixing a shaft to a hub rotatably mounted thereon, for example, an idler gear. The connecting clutch, therefore, is designed as a gearshift clutch and, preferably, also as part of an engagement device and is referred to as a clutch only because the connecting clutch connects two shafts to each other.

Preferably, at least a portion of the clutches and/or gearshift clutches can be designed as a dog clutch. In particular, all clutches and gearshift clutches can be designed as dog clutches.

In addition, the transmission device can include a control device. The control device is designed for controlling the transmission, by way of an open-loop system, as described.

Example aspects of the invention also relate to a hybrid transmission device including at least one drive device and one transmission device. The hybrid transmission device is distinguished by the fact that the transmission device is designed as described.

Preferably, the hybrid transmission device can include at least two, in particular precisely two, drive devices. An arrangement of one or multiple drive device(s) that act(s) at a certain point of the hybrid transmission device counts as a drive device. This means, for example, in an example embodiment of the drive devices as electric motors, that multiple small electric motors can also be considered to be one electric motor if the multiple small electric motors summarize their torque at a single starting point.

Advantageously, at least one drive device can be associated with the first transmission input shaft and at least one drive device can be associated with the second transmission input shaft. The gears implemented via the first transmission input shaft and the gears implemented via the second transmission input shaft form a sub-transmission in each case. It may therefore also be stated that at least one drive device is associated with each sub-transmission. Preferably, the hybrid transmission device includes at least two, in particular precisely two, sub-transmissions.

Preferably, at least one of the drive devices is designed as a generator.

Preferably, the first drive device and/or the second drive device are/is designed as a motor and as a generator.

Preferably, one drive device is connected to an axially externally situated gear step, more precisely, to one of the gearwheels of the gear step, of the transmission.

At this point, it is to be pointed out that, in the present invention, a connection or operative connection refers to any power flow-related connection, also across other components of the transmission. A point of connection, however, refers to the first connecting point for transmitting drive torque between the drive device and the transmission.

A connection to a gear step, i.e., one of the gear-step gearwheels of the gear step, can take place via a gearwheel. An additional intermediate gear may be necessary in order to bridge the center distance between the output shaft of the drive device and the transmission input shaft and/or the gearwheel mounted thereon. Due to the connection of the drive device to a gear-step gearwheel, a further gear plane can be avoided, which would be present only for connecting the drive device.

Advantageously, at least one, in particular precisely one, of the axially external gear-step gears, which are arranged on the axis of the transmission input shafts, can be designed as a fixed gear.

Preferably, one drive device can be connected to the second gear step and to the third gear step.

Preferably, the second drive device can be connected to the internal combustion engine in all internal-combustion-engine forward gears and/or during an internal-combustion-engine gear change. In this case, a constant connection exists between the internal combustion engine and the second drive device during internal combustion engine-driven travel. Preferably, the second drive device can be utilized, at least intermittently, as a generator in all forward gears.

Preferably, the first drive device can be utilized for starting off in the forward direction in an electric or fluidic manner. In this case, the second drive device can be coupled, advantageously, to the gear-step gears of the first gear. The starting-off is always performed by the first drive device in this case. The first drive device can preferably be utilized as the sole drive source for the starting-off. Likewise, the first drive device can be utilized for electric or fluidic travel in reverse. Preferably, it can also be provided here that the first drive device is the sole drive source during travel in reverse. In this case, there are no internal-combustion-engine or hybrid reverse gears.

Preferably, a drive device can be arranged axially parallel to the first transmission input shaft. The drive device is then preferably also axially parallel to the second transmission input shaft and to the countershafts. In the present invention, an axially parallel arrangement refers not only to completely parallel arrangements. An inclination or an angle between the longitudinal axis of the transmission input shafts and the longitudinal axis of the electric motor can also be present. Preferably, an angle is provided between the longitudinal axis of an electric motor and the longitudinal axis of the transmission input shafts of less than or equal to ten degrees (10°), further preferably less than five degrees (5°)and, in particular zero degrees (0°). Slight inclinations of the drive devices in comparison to the transmission can result for reasons related to installation space.

In addition, the other drive device can be arranged coaxially to the first transmission input shaft and/or the second transmission input shaft. Preferably, the connection point of the internal combustion engine and the connection point of the coaxial drive device can be arranged at opposite ends of the hybrid transmission device.

Preferably, the coaxial drive device and the connection point of the internal combustion engine can be arranged at different transmission input shafts. The coaxial drive device and the internal combustion engine are then associated with different sub-transmissions.

The axially parallel drive device can be arranged in the axial direction preferably at the same level as the gear change transmission. Preferably, the overlap in the axial direction can be more than seventy-five percent (75%). Advantageously, the axial overlap is one hundred percent (100%). Here, the overlap is ascertained on the basis of the housing of the drive device. The output shaft of the drive device is not taken into account.

Preferably, the first drive device and/or the second drive device can be designed as an electric motor. Electric motors are widespread in hybrid transmission devices.

Alternatively or additionally, the first drive device and/or the second drive device can be designed as a fluid power machine. In addition to electric motors, there are other prime movers, the utilization of which in hybrid transmission devices is conceivable. These can also be operated as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Advantageously, the first drive device and the second drive device can be power-shifted. A powershift is understood here, as usual, to mean that no interruption of tractive force occurs at the output of the hybrid transmission device during a gear change, for example, of the first drive device. A reduction of the torque present at the drive output is possible, but a complete interruption is not.

As a result, the motor vehicle can be continuously driven in large speed ranges, for example, exclusively electrically, wherein the ratio, i.e., the gear, is selected in each case so as to be optimized with respect to the rotational speed and torque of the drive device.

Preferably, the second drive device can output torque to the drive output while the first drive device is shifted. In other words, the gear step is changed, via which the first drive device transmits torque to the drive output.

Preferably, the first drive device can output torque to the drive output while the second drive device is shifted. This means, the gear step is changed, via which the second drive device transmits torque to the drive output. It may therefore also be stated that the drive devices are power shiftable with one another. The internal combustion engine therefore does not need to be started for a gear change during electric travel.

Preferably, at least one of the drive devices can be connected to the transmission via a P3 connection. In a P3 connection, the drive devices engage at the transmission between the input shaft and the output shaft.

Advantageously, both drive devices can be operatively connected to a differential via, at most, four meshing points. As a result, good efficiency is achieved.

Example aspects of the invention also relate to a hybrid drive train including an internal combustion engine and a hybrid transmission device. The hybrid drive train is distinguished by the fact that the hybrid transmission device is designed as described.

Preferably, the hybrid drive train can include at least one electric axle, in particular a rear axle. This configuration is preferably arranged with a single drive device in the hybrid transmission device. An electric axle is an axle having an electric motor associated therewith. The output of drive torque by the electric motor of the electric axle therefore first takes place in the power flow behind the hybrid transmission device. Preferably, the electric axle is an assembly unit. The assembly unit can also include a separate transmission for multiplying the drive torque of the electric motor of the electric axle. This is preferably designed as a gear change transmission.

When an electric axle is utilized, the electric axle can support the drive torque.

Example aspects of the invention also relate to a motor vehicle with an internal combustion engine and a hybrid transmission device or a hybrid drive train. The motor vehicle is distinguished by the fact that the hybrid transmission device or the hybrid drive train is designed as described.

Advantageously, the hybrid transmission device is arranged in the motor vehicle as a front-mounted transverse transmission device.

Preferably, the motor vehicle includes a control device for the open-loop control of the hybrid transmission device. The control device can therefore be part of the hybrid transmission device, although the control device does not need to be.

Preferably, a battery is arranged in the motor vehicle, which allows for an electric operation of the motor vehicle for at least fifteen (15) minutes. Alternatively, for a purely electric operation, the internal combustion engine, with one of the electric motors as a generator, can generate current, which goes directly to the other electric motor.

In addition, the motor vehicle can include a pressure reservoir. This can be utilized for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle;

FIG. 2 shows a hybrid transmission arrangement in a first example embodiment;

FIG. 3 shows a first gear shift matrix for FIG. 2;

FIG. 4 shows a second gear shift matrix for FIG. 2;

FIG. 5 shows a third gear shift matrix for FIG. 2;

FIG. 6 shows a diagram for FIG. 2;

FIG. 7 shows a hybrid transmission arrangement in a second example embodiment;

FIG. 8 shows a hybrid transmission arrangement in a third example embodiment;

FIG. 9 shows a hybrid transmission arrangement in a fourth example embodiment; and

FIG. 10 shows a hybrid transmission arrangement in a fifth example embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

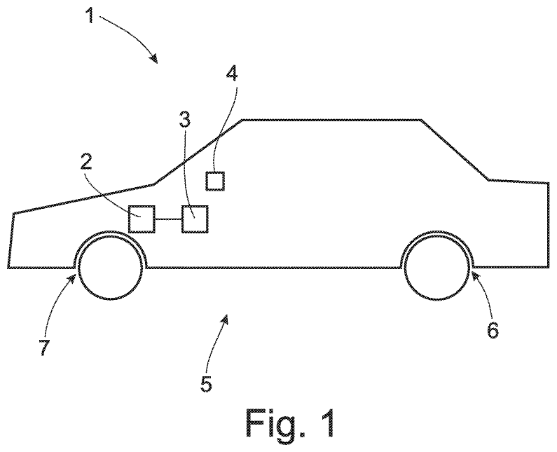

FIG. 1 shows a motor vehicle 1 with an internal combustion engine 2 and a hybrid transmission device 3. The hybrid transmission device 3 also includes, as described in greater detail further below, an electric motor, allowing the hybrid transmission device 3 to be installed as an assembly unit. This is not absolutely necessary, however. In principle, the hybrid transmission device 3 can also form an assembly unit without a previously connected electric motor. A control device 4 is provided for the open-loop control of the hybrid transmission device 3. This can be part of the hybrid transmission device 3 or of the motor vehicle 1.

The hybrid drive train 5 can also include, in addition to the internal combustion engine 2 and the hybrid transmission device 3, at least one electric axle 6. The electric axle 6 is preferably arranged at the rear axle when the hybrid transmission device 3 is a front-mounted transverse transmission and drives the front axle 7, and vice versa.

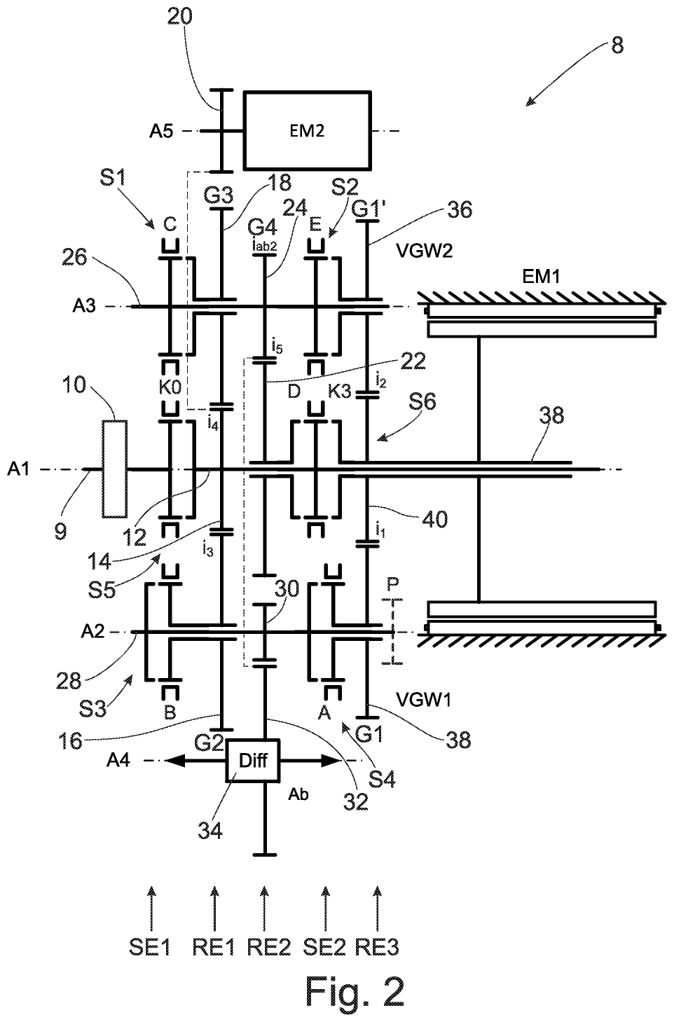

FIG. 2 shows a hybrid transmission arrangement 8 in a first example embodiment. The hybrid transmission arrangement 8 is one possible example embodiment of the hybrid transmission arrangement 3 according to FIG. 1.

The hybrid transmission arrangement 8 is described starting from the internal combustion engine 2 and/or a crankshaft 9 of the the internal combustion engine 2. The hybrid transmission arrangement 8 is connected to the crankshaft 9 via a damping device 10. The damping device 10 can include a torsion damper and/or a damper and/or a slipping clutch. The torsion damper can be designed as a dual-mass flywheel and the damper can be designed as a rotational speed-adaptive damper.

The first transmission input shaft 12 is then connected to the damping device 10 via a separating clutch K0. A single fixed gear 14 is located on the first transmission input shaft 12 and intermeshes with two idler gears 16 and 18 as well as with a gearwheel of an electric motor EM2. Instead of directly intermeshing with a gearwheel 20 on the output shaft of the electric motor EM2, the fixed gear 14 can also intermesh with an interconnected intermediate gear to the gearwheel 20.

In addition, an idler gear 22 is arranged on the first transmission input shaft 12, which intermeshes with a connecting gearwheel 24 and simultaneously forms a gear step G4. This implements the gear stage i5. The connecting gearwheel 24, similarly to the idler gear 18, is mounted on the countershaft 26. In addition to the first countershaft 26, the hybrid transmission arrangement 8 also includes a second countershaft 28.

A connecting gearwheel 30 is also arranged on the second countershaft 28. The gearwheel 32 of the differential 34 intermeshes with the first connecting gearwheel 24 as well as with the second gearwheel 30.

A second idler gear 38, in addition to the idler gear 18 and the connecting gearwheel 24, is arranged on the first countershaft 26.

Moreover, the idler gear 38, in addition to the second connecting gearwheel 30 and the idler gear 16, is arranged on the second countershaft 28. Therefore, the countershafts 26 and 28 are symmetrically arranged with respect to the axis A1 of the transmission input shafts. This applies not only with respect to the fixed gears and idler gears, but rather also with respect to the engagement devices S1, S2, S3, and S4 including the gearshift clutches A, B, C, and E. These are preferably designed as one-sided engagement devices and each include a single gearshift clutch. All gearshift clutches and engagement devices on the countershafts are arranged on the side of the internal combustion engine and the idler gears are arranged on the side of the first electric machine EM1.

On the axis of the first transmission input shaft 12 and the second transmission input shaft 38, the separating clutch K0 is located in the engagement device S5 and the gearshift clutch D and the connecting clutch K3 are located in the engagement device S6. The engagement device S6, therefore, is the only two-sided engagement device of the hybrid transmission arrangement 8. The first transmission input shaft 12 and the second transmission input shaft 38 can be connected to each other in a rotationally fixed manner by engaging the connecting clutch K3. As a result, the gear steps G1 and G1′ formed with the gear stages i1 and i2 can be coupled to the internal combustion engine, wherein, as described further below, only the gear step G1 is utilized for producing an internal-combustion-engine gear V1. The electric motor EM1 is rotationally fixed to the second transmission input shaft 38. Therefore, a connection can also be established between the internal combustion engine 2 and the electric motor EM1 via the connecting clutch K3. In addition, the electric motor EM1 and the internal combustion engine 2 can be decoupled from each other via the connecting clutch K3.

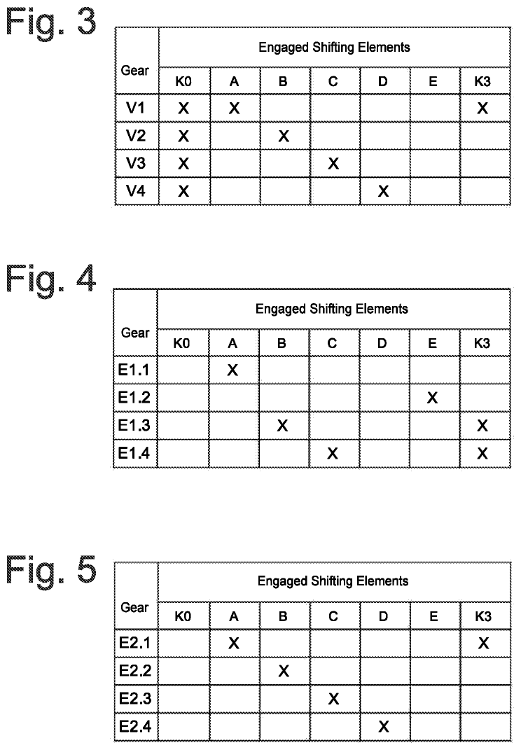

FIG. 3 shows a gear shift matrix for the internal-combustion-engine gears V1 through V4. The separating clutch K0 is engaged in these cases. Only the first transmission input shaft 12 is utilized in order to engage the gears V2 through V4, wherein the gears are engaged by engaging the gearshift clutches B through D. For the first gear, the first gear step G1 including the gear stage i1 is utilized. For this purpose, the connecting clutch K3 as well as the gearshift clutch A must be engaged.

FIG. 4 shows four electric gears E1.1 through E1.4 for the first electric motor EM1. The gear step G1 is also utilized for implementing the first electric gear E1.1 of the first electric motor EM1. Therefore, the gearshift clutch K is engaged. The separating clutch K0 can be disengaged, however, in order to decouple the internal combustion engine 2.

The gear step G1′ is utilized for implementing the second gear E1.2 of the electric motor EM1. The fixed gear 40 and the idler gear 36 form the gear stage i2. The ratio of the gear step G1′ is smaller than that of the gear step G1, but larger than that of the gear step G2. As a result, an improved ratio in the second electric gear E1.2 can be obtained for the first electric motor EM1.

For the third electric gear E1.3 for the electric motor EM1, the second gear step G2 including the gear stage i3 is utilized, which, as described, has a smaller ratio of the gear step G1′. The third gear step G3 including the gear stage i4 is utilized for implementing the fourth electric gear E1.4 of the first electric machine EM1. In the electric gears E1.3 and E1.4, the connecting clutch K3 is to be engaged in addition to the gearshift clutch B and C, respectively.

The electric machine EM1 therefore utilizes the gear steps G1 through G3 and, additionally, the interstage G1′ in order to implement four electric gears E1.1 through E1.4.

FIG. 5 shows a gear shift matrix for the second electric machine EM2. This is implemented in the same sub-transmission as the internal combustion engine 2, which is why the gear shift matrix is similarly designed. In contrast to the gear shift matrix according to FIG. 3, however, the separating clutch K0 is disengaged in order to decouple the internal combustion engine and, thereby, drag losses. The same gears would also be implemented, however, upon engagement of the separating clutch K0.

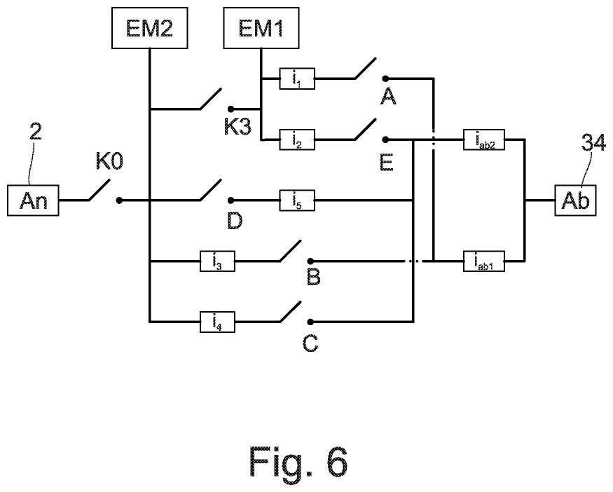

FIG. 6 shows a shift logic of the hybrid transmission arrangement 8 according to FIG. 2. It is clearly apparent that the gear steps G1 and G1′ can be coupled by disengaging the connecting clutch K3. In particular, the electric machine EM1 can also be connected to the electric machine EM2 or to the internal combustion engine 2 via the connecting clutch K3.

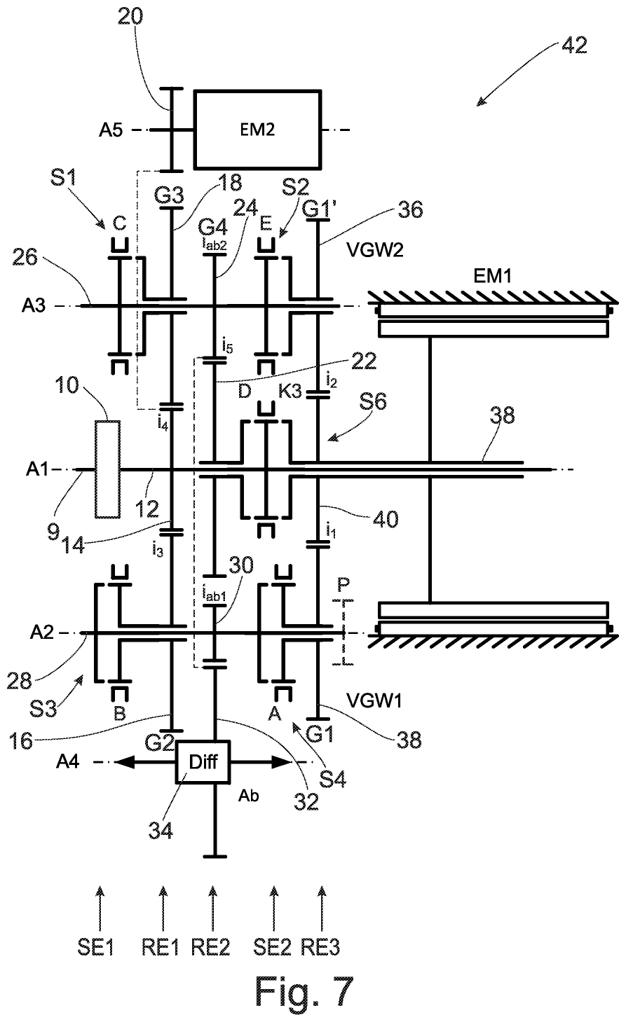

FIG. 7 shows one further example hybrid transmission arrangement 42. This is designed identically to FIG. 2 with the exception that the separating clutch K0 has been omitted. Only five engagement devices in the engagement device planes SE1 and SE2 are then located on the axes A1, A2, and A3.

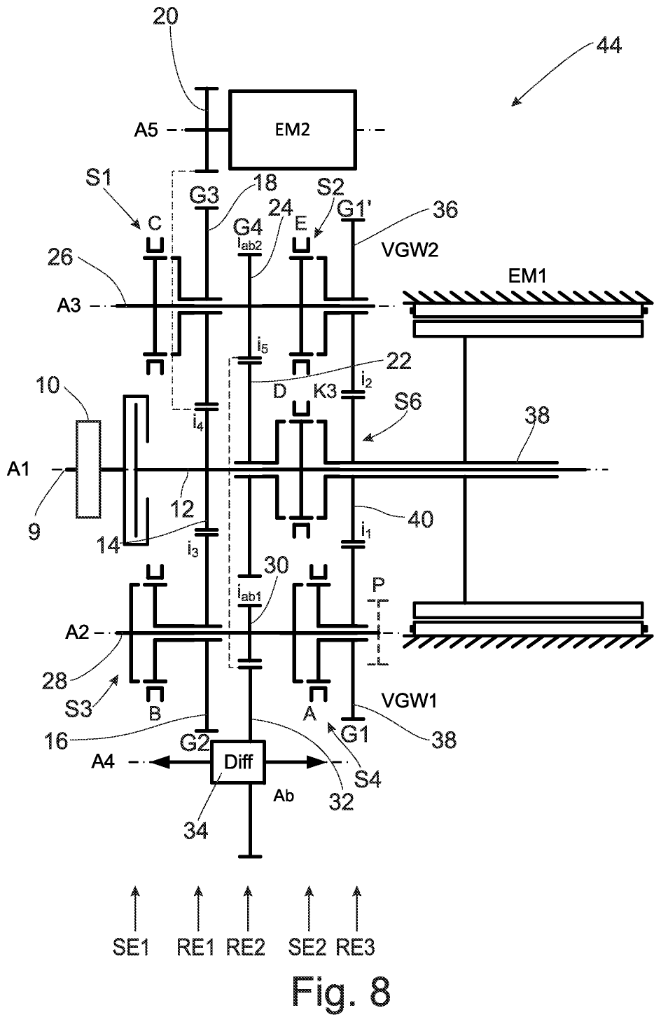

FIG. 8 shows a third example embodiment of a hybrid transmission arrangement 44. In contrast to FIG. 2, the separating clutch K0 is designed as a friction clutch. Otherwise, the hybrid transmission arrangements 8 and 44 are identically designed. Due to the design of the separating clutch K0 as a friction clutch, this can also be disengaged under load, for example, during a full brake application or a malfunction in the internal combustion engine 2. The separating clutch K0 can then also be engaged at a differential speed in order to enable a flywheel start of the internal combustion engine 2 via the electric machine EM2.

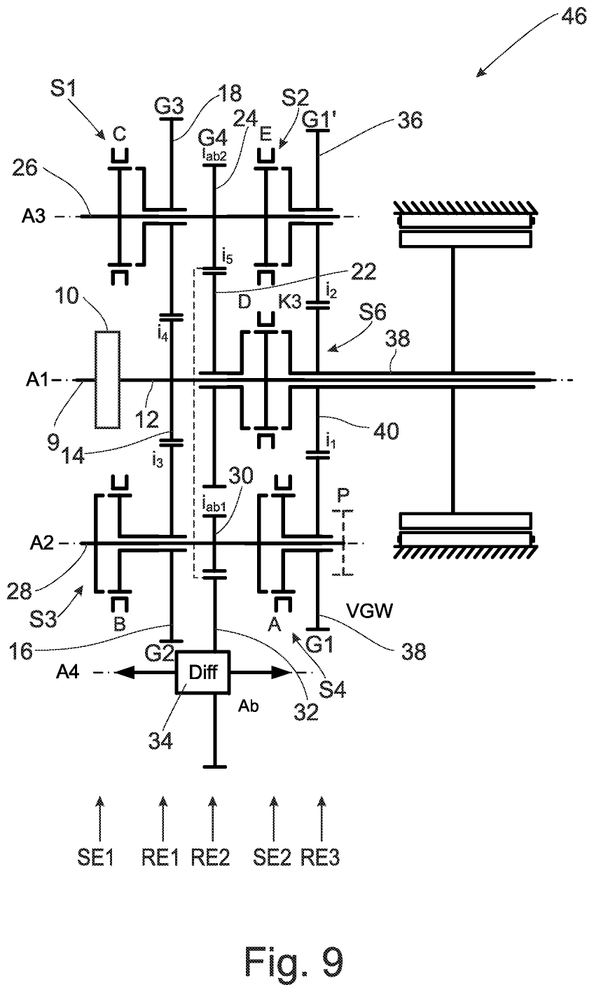

FIG. 9 shows a fourth example embodiment of a hybrid transmission arrangement 46. This results from the hybrid transmission arrangement according to FIG. 2 in such a way that both the separating clutch K0 as well as the second electric machine EM2 have been omitted. Therefore, the gear shift matrix has no separating clutch, in deviation from FIG. 3. As a result, the internal combustion engine 2 can no longer be decoupled. The gear shift matrix according to FIG. 3 would therefore also need to be modified. Since the second electric machine EM2 has been omitted, the hybrid transmission arrangement 46 according to FIG. 9 does not include a gear shift matrix as in FIG. 5.

The omission of the electric motor EM2 can also occur starting from the example embodiments according to FIG. 7 or FIG. 8. Therefore, there is a compelling relationship between the utilization of the electric motor 2 and the form of the separating clutch K0.

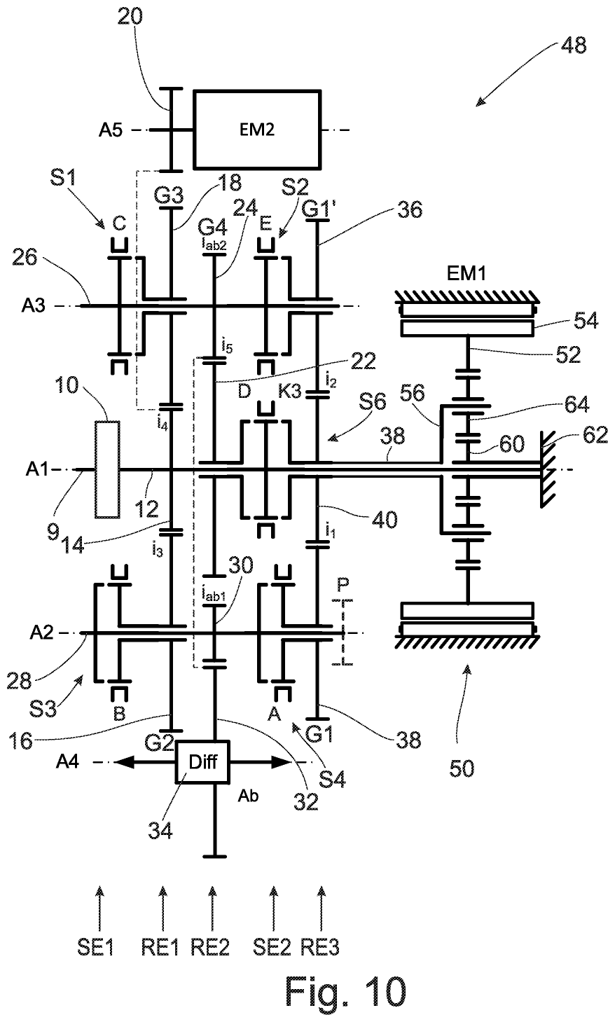

FIG. 10 shows a fifth example embodiment of a hybrid transmission arrangement 48. This shows an example embodiment, in which an HEV configuration is made possible. In this case, only one small battery having limited power is available. Therefore, the electric machine EM2 is not utilized as a propulsive machine, but rather as a generator. For this reason, the electric machine EM1 is equipped with a pre-ratio in the form of a planetary gear set 50. The ring gear 52 of the planetary gear set is coupled to the rotor 54 of the electric machine and the output shaft 38 is coupled to the planet carrier 56. The sun gear 60 is fixedly connected to the transmission housing 62 and the planet gears 62 are arranged in a freely movable manner. A separating clutch K0 is not implemented in the hybrid transmission arrangement 48, either, although this can be utilized in all example embodiments shown.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission arrangement
4 control device
5 hybrid drive train
6 electric axle
7 front axle
8 hybrid transmission arrangement
9 crankshaft
10 damping device
12 first transmission input shaft
14 fixed gear
16 idler gear
18 idler gear
20 gearwheel
22 idler gear
24 connecting gearwheel
26 countershaft
28 countershaft
30 connecting gearwheel
32 gearwheel
34 differential
36 idler gear
37 idler gear
38 second transmission input shaft
40 fixed gear
42 hybrid transmission arrangement
44 hybrid transmission arrangement
46 hybrid transmission arrangement
48 hybrid transmission arrangement
50 planetary gear set
52 ring gear
54 rotor
56 planet carrier
60 sun gear
62 transmission housing
64 planet gear

1-15. (canceled)

16. A transmission arrangement (3, 8, 42, 44, 46, 48), comprising:
at least one transmission input shaft (12, 38);
at least one countershaft (26, 28); and
a connecting gearwheel (24) arranged on the at least one countershaft (26) and configured for connecting a differential (34),
wherein the connecting gearwheel (24) is connected to a gearwheel (22) for forming a gear step (G4).

17. The transmission arrangement of claim 16, wherein the gearwheel is configured as an idler gear (22).

18. The transmission arrangement of claim 16, wherein the gearwheel (22) is arranged on a first transmission input shaft (12) of the at least one transmission input shaft (12, 38).

19. The transmission arrangement of claim 16, wherein the connecting gearwheel (24) is arranged at a middle portion of the at least one countershaft (26).

20. The transmission arrangement of claim 16, wherein:
the at least one countershaft (26, 28) comprises a first countershaft (26) and a second countershaft (28);
the connecting gearwheel (24) is a first connecting gearwheel (24) and is arranged on the first countershaft (26); and
a second connecting gearwheel (30) is arranged on the second countershaft (28) and configured for connecting the differential (34).

21. The transmission arrangement of claim 20, wherein the second connecting gearwheel (30) and the first connecting gearwheel (24) are situated in a common gear set plane (RE2).

22. The transmission arrangement of claim 16, wherein the at least one transmission input shaft (12, 38) comprises a first transmission input shaft (12) and a second transmission input shaft (38).

23. The transmission arrangement of claim 22, further comprising a connecting clutch (K3), the first transmission input shaft (12) and the second transmission input shaft (38) connectable by the connecting clutch (K3).

24. The transmission arrangement of claim 23, further comprising a gearshift clutch (D) for connecting the gearwheel (22) to a shaft (12), wherein the connecting clutch (K3) and the gearshift clutch (D) are arranged in a two-sided engagement device (S6).

25. The transmission arrangement of claim 16, wherein the transmission arrangement (3, 8, 42, 44, 46, 48) comprises only two countershafts (26, 28).

26. The transmission arrangement of claim 16, wherein at least one engagement device (S1, S2, S3, S4) is arranged at each of the at least one countershaft (26, 28).

27. The transmission arrangement of claim 16, wherein the transmission arrangement (3, 8, 42, 44, 46, 48) comprises only three gear set planes (RE1, RE2, RE3).

28. A hybrid transmission arrangement, comprising:
the transmission arrangement of claim 16; and
at least one drive device (EM1, EM2) connected to the transmission arrangement (3, 8, 42, 44, 46, 48).

29. A hybrid drive train, comprising:
an internal combustion engine; and
the hybrid transmission arrangement of claim 28.

30. A motor vehicle, comprising the hybrid transmission arrangement of claim 28.

31. A motor vehicle, comprising the hybrid drive train of claim 29.
